(19) United States
(12) Patent Application Publication
(10) Pub. No.: US 2016/0244556 A1
(43) Pub. Date: Aug. 25, 2016

(54) BIODEGRADABLE POLYESTER RESIN AND ARTICLE COMPRISING SAME

(71) Applicant: LOTTE FINE CHEMICAL CO., LTD., Ulsan (KR)

(72) Inventors: Min Kyoung Kim, Seoul (KR); Sang Mi Kang, Daejeon (KR); Ji Soo Ahn, Daejeon (KR); Ki Chull Yoon, Gyeonggi-do (KR)

(21) Appl. No.: 15/031,163

(22) PCT Filed: Oct. 16, 2014
(86) PCT No.: PCT/KR2014/009719

§ 371 Date: Apr. 21, 2016

(30) Foreign Application Priority Data
Oct. 24, 2013 (KR) 10-2013-0127302

(51) Int. Cl. C08G 63/199

(52) U.S. Cl. CPC C08G 63/199

(57) ABSTRACT

A biodegradable polyester resin and an article including the same are provided. The biodegradable polyester resin includes a diol residue (DO) that includes a cycloaliphatic diol residue (A) and an aliphatic diol residue (B); and a dicarboxylic acid residue (DC) that includes at least one of an aromatic dicarboxylic acid residue (C), an aliphatic dicarboxylic acid residue (D), and a cycloaliphatic dicarboxylic acid residue (E). Thus, the biodegradable polyester resin may have an excellent transparency and flexibility.

### TECHNICAL FIELD

One or more embodiments of the present invention relate to a biodegradable polyester resin and an article including the same, and more particularly, to a biodegradable polyester resin having excellent transparency and flexibility, and an article including the same.

### BACKGROUND ART

Plastic has been widely used in daily life since it is a high-functional and durable material. Conventional plastic, however, has many problems including having a low decomposition rate by microorganisms when buried, and discharging harmful gases when incinerated, thereby causing environmental pollution. Therefore, research into a biodegradable plastic has been developed.

Among biodegradable plastics, a biodegradable polyester resin is in the spotlight. The biodegradable polyester resin refers to a polymer that can be decomposed into water and carbon dioxide, or water and methane gas by natural microorganisms such as bacteria, algae, and fungi. This biodegradable polyester resin has recently been suggested as a compelling solution to prevent pollution of the environment due to landfills or incineration.

Some biodegradable polyester resins such and polybutylene succinate (PBS) and polybutylene adipate-co-terephthalate (PBAT) are, however, opaque. Therefore, it has been limited to use the resins in applications requiring its transparency such as transparent packaging vinyls and transparent plastic containers. Even though polylactic acid (PLA) has a transparency, it is easily decomposed under high temperature and high humidity conditions. Also, PLA has high brittleness so that its application to such an application field has been limited.

### DETAILED DESCRIPTION OF THE INVENTION

### Technical Problem

An embodiment of the present invention provides biodegradable polyester resin having excellent transparency and flexibility.

Another embodiment of the present invention provides an article including the biodegradable polyester resin.

### Technical Solution

According to an aspect of the present invention, the biodegradable polyester resin includes:

a diol residue (DO) that includes a cycloaliphatic diol residue (A) and an aliphatic diol residue (B); and a dicarboxylic acid residue (DC) that includes at least one of an aromatic dicarboxylic acid residue (C), an aliphatic dicarboxylic acid residue (D), and a cycloaliphatic dicarboxylic acid residue(E).

The cycloaliphatic diol residue (A) may include a residue derived from at least one cycloaliphatic diol compound that is selected from the group consisting of 2,2,4,4-tetramethyl-1,3-cyclobutanediol, 1,2-cyclopentanediol, 1,3-cyclopentanediol, 1,2-cyclopentane dimethanol, 1,3-cyclopentane dimethanol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, and a combination thereof while the aliphatic diol residue (B) may include a residue derived from at least one diol compound that is selected from the group consisting of ethylene glycol, and a branched aliphatic diol (B-DO) having an ethylene glycol moiety.

The branched aliphatic diol (B-DO) may include at least one aliphatic diol compound selected from the group consisting of 1,2-propanediol, 2,3-butanediol, 2-methyl-2,3-butanediol, 2,3-dimethyl-2,3-butanediol, 4-methyl-2,3-pentanediol, and a combination thereof.

The aromatic dicarboxylic acid residue (C) may include a residue derived from at least one aromatic dicarboxylic acid compound that is selected from the group consisting of terephthalic acid, isophthalic acid, naphthoic acid, naphthalene dicarboxylic acid, and derivatives thereof.

The aliphatic dicarboxylic acid residue (D) may include a residue derived from at least one aliphatic dicarboxylic acid compound that is selected from the group consisting of succinic acid, glutaric acid, adipic acid, pimelic acid, suberic acid, azelaic acid, malic acid, malonic acid, oxalic acid, sebacic acid, and derivatives thereof.

The cycloaliphatic dicarboxylic acid residue (E) may include a residue derived from at least one cycloaliphatic dicarboxylic acid compound that is selected from the group consisting of cyclobutane dicarboxylic acid, cyclopentane dicarboxylic acid, cyclohexane dicarboxylic acid, and derivatives thereof.

The amount of the diol residue (DO) may be in a range of about 1.0 part by mole to about 2 parts by mole based on 1 part by mole of the dicarboxylic acid residue (DC).

The amounts of the cycloaliphatic diol residue (A) and the aliphatic diol residue (B) may be in ranges of about 0.1 part by mole to about 0.6 part by mole, and about 0.4 part by mole to about 0.9 part by mole, respectively based on 1 part by mole of the diol residue (DO).

The amounts of the aromatic dicarboxylic acid residue (C), the aliphatic dicarboxylic acid residue (D), and the cycloaliphatic dicarboxylic acid residue (E) may be in ranges of about 0 part by mole to about 0.7 part by mole, about 0 part by mole to about 0.5 part by mole, and about 0 part by mole to about 1.0 part by mole, respectively based on 1 part by mole of the dicarboxylic acid residue (DC).

The biodegradable polyester resin may have a weight average molecular weight (Mw) in a range of about 50,000 to about 150,000.

The biodegradable polyester resin may have a glass transition temperature (T_{g}) of 25° C. or greater.

The biodegradable polyester resin may include at least one compound selected from the group consisting of poly(ethylene-1,4-cyclohexanedimethylene succinate terephthalate) (PECST), poly(ethylene-1,4-cyclohexanedimethylene adipate terephthalate) (PECAT), poly (1,2-propylene-1,4-cyclohexanedimethylene succinate terephthalate) (P 12PCST), poly (ethylene-1,4-cyclohexanedimethylene 1,4-cyclohexane dicarboxylate terephthalate) (PECCT) and poly(ethylene-1,4-cyclohexanedimethylene succinate adipate terephthalate) (PECSAT).

According to another aspect of the present invention,

an article including the biodegradable polyester resin is provided.

### Advantageous Effects of the Invention

According to an embodiment of the present invention, the biodegradable polyester resin having an excellent flexibility and transparency may be provided.

According to another embodiment of the present invention, the article including the biodegradable polyester resin may be provided.

### DESCRIPTION OF THE DRAWINGS

FIG. 1 shows a graph representing light transmittance of resins prepared in Examples 1-7, a polylactic acid (PLA) resin, and a polybutylene succinate (PBS) resin.

FIG. 2 shows a graph representing a biodegradability of each of resins prepared in Examples 1-7 and Comparative Examples 1-2.

### BEST MODE

Hereinafter, the biodegradable polyester resin according to an embodiment of the present invention will be explained in detail.

The term “polyester” used herein refers to a synthetic polymer prepared by an esterification reaction and a polycondensation reaction of one or more di-functional or three or more multi-functional carboxylic acids, and one or more di-functional or three or more multi-functional hydroxyl compounds.

The term ┌residue┘ used herein refers to a certain part or a unit derived from a specific compound and then included in a product of a chemical reaction, when the specific compound participates in the reaction.

The term “aliphatic” used herein refers to a linear or branched atomic arrangement that is not cyclic (i.e. an aromatic ring and an cycloaliphatic ring are not included therein) and has at least one valency.

The term “aromatic” used herein refers to an atomic arrangement that has at least one valency and includes one or more aromatic groups. The atomic arrangement may include heteroatoms such as nitrogen, sulfur, selenium, silicon, and oxygen, or may be composed exclusively of carbon and hydrogen.

The term “cycloaliphatic” used herein refers to an atomic arrangement that is cyclic but is not aromatic. A cycloaliphatic group may include heteroatoms such as nitrogen, sulfur, selenium, silicon, and oxygen in a ring, or may be composed exclusively of carbon and hydrogen.

A biodegradable polyester resin according to an embodiment of the present invention may include a diol residue (DO) including cycloaliphatic diol residue (A) and aliphatic diol residue (B); and a dicarboxylic acid residue (DC) that includes at least one of aromatic dicarboxylic acid residue (C), aliphatic dicarboxylic acid residue (D), and cycloaliphatic dicarboxylic acid residue (E).

The cycloaliphatic diol residue (A) may include a residue derived from at least one cycloaliphatic diol compound selected from the group consisting of 2,2,4,4-tetramethyl-1,3-cyclobutanediol, 1,2-cyclopentanediol, 1,3-cyclopentanediol, 1,2-cyclopentanedimethanol, 1,3-cyclopentanedimethanol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, and a combination thereof.

The aliphatic diol residue (B) may include a residue derived from at least one diol compound that is selected from ethylene glycol, and a branched aliphatic diol(B-DO) having an ethylene glycol moiety.

The branched aliphatic diol (B-DO) may include at least one aliphatic diol compound selected from the group consisting of 1,2-propanediol, 2,3-butanediol, 2-methyl-2,3-butanediol, 2,3-dimethyl-2,3-butanediol, 4-methyl-2,3-pentanediol, and a combination thereof.

For example, the cycloaliphatic diol residue (A) may be a residue derived from 1,4-cyclohexanediol and the aliphatic diol residue (B) may be a residue derived from ethylene glycol.

The biodegradable polyester resin having the cycloaliphatic diol residue (A) may have an increased polymeric structural irregularities and thus have a higher glass transition temperature T_{g} compared to the biodegradable polyester resin having only the aliphatic diol residue (B). This is because the glass transition temperature tends to increase as a molecular structure of polymer becomes more irregular.

For example, the branched aliphatic diol (B-DO) having an ethylene glycol moiety is selected from 1,2-propanediol, 2,3-butanediol, 2-methyl-2,3-butanediol, 2,3-dimethyl-2,3-butanediol and 4-methyl-2,3-pentanediol, and when a biodegradable polyester resin is prepared therefrom, the biodegradable polyester resin may have a more irregular molecular structure and thus a higher T_{g} than the biodegradable polyester resin prepared from ethylene glycol.

The aromatic dicarboxylic acid residue (C) may include a residue derived from at least one aromatic dicarboxylic acid compound that is selected from the group consisting of terephthalic acid, isophthalic acid, naphthoic acid, naphthalene dicarboxylic acid, and a derivative thereof.

The aliphatic dicarboxylic acid residue (D) may include a residue derived from at least one aliphatic dicarboxylic acid compound that is selected from succinic acid, glutaric acid, adipic acid, pimelic acid, suberic acid, azelaic acid, maleic acid, malonic acid, oxalic acid, sebacic acid, and a derivative thereof.

The cycloaliphatic dicarboxylic acid residue (E) may include a residue derived from at least one cycloaliphatic dicarboxylic acid compound that is selected from cyclobutane dicarboxylic acid, cyclopentane dicarboxylic acid, cyclohexane dicarboxylic acid, and a derivative thereof.

The term “dicarboxylic acid compound” used herein refers to a compound including a dicarboxylic acid and a dicarboxylic acid derivative.

The term “dicarboxylic acid derivatives” used herein refers to a compound including ester derivatives of dicarboxylic acid, derivatives of acyl halide of dicarboxylic acid, and anhydride derivatives of dicarboxylic acid.

When the dicarboxylic acid compound and the diol compound reacts stoichiometrically in the polymerization for preparing the biodegradable polyester resin, the dicarboxylic acid compound and the diol compound may react in a mole ratio of 1:1. The ratio of the amount of the diol compound used to the amount of the dicarboxylic acid compound used may be 1:1, but in order to facilitate a reaction and increase a yield of the biodegradable polyester resin, an excessive amount of the diol compound may be used with respect to that of the dicarboxylic acid compound. Therefore, an amount of the diol residue (DO) may be in the range of about 1.0 part by mole to about 2.0 parts by mole based on 1 part by mole of the dicarboxylic acid residue (DC).

Amounts of the cycloaliphatic diol residue (A) and the aliphatic diol residue (B) may be in range of about 0.1 part by mole to about 0.6 part by mole, and about 0.4 part by mole to about 0.9 part by mole, respectively, based on 1 part by mole of the diol residue (DO).

When amounts of the cycloaliphatic diol residue (A) and the aliphatic diol residue (B) are respectively within the aforementioned ranges, the biodegradable polyester resin may have a glass transition temperature (T_{g}) of 25° C. or greater and the polymerization rate of the biodegradable polyester resin may be increased.

The amounts of the aromatic dicarboxylic acid residue (C), the aliphatic dicarboxylic acid residue (D), and the cycloaliphatic dicarboxylic acid residue (E) may be in a range or about 0 part by mole to about 0.7 part by mole, about 0 part by mole to about 0.5 part by mole, and about 0 part by mole to about 1.0 part by mole, respectively, based on 1 part by mole of the dicarboxylic acid residue (DC).

When the amounts of the aromatic dicarboxylic acid residue (C), the aliphatic dicarboxylic acid residue (D) and the cycloaliphatic dicarboxylic acid residue (E) are respectively within the aforementioned ranges, the biodegradable polyester resin may have a T_{g} of 25° C. or greater.

The biodegradable polyester resin may have a weight average molecular weight (Mw) in a range of about 50,000 to about 150,000. When the weight average molecular weight (Mw) of the biodegradable polyester resin is within the aforementioned range, the biodegradable polyester resin may have high mechanical strength and a suitable viscosity for injection molding or a die-casting process.

The biodegradable polyester resin may have the glass transition temperature (T_{g}) of 25° C. or greater. When the glass transition temperature (T_{g}) of the biodegradable polyester resin is 25° C. or greater, the biodegradable polyester resin may be solidified rapidly even at room temperature (20° C.).

The biodegradable polyester resin may include at least one compound selected from the group consisting of poly(ethylene-1,4-cyclohexanedimethylene succinate terephthalate) (PECST), poly(ethylene-1,4-cyclohexanedimethylene adipate terephthalate) (PECAT), poly (1,2-propylene-1,4-cyclohexanedimethylene succinate terephthalate) (P 12PCST), poly(ethylene-1,4-cyclohexanedimethylene 1,4-cyclohexanedicarboxylate terephthalate) (PECCT) and poly(ethylene-1,4-cyclohexanedimethylene succinate adipate terephthalate) (PECSAT).

The biodegradable polyester resin may have advantages to be decomposable even under composting conditions; more flexible than polylactic acid (PLA); and suitable for injection molding or a die-casting process.

According to another embodiment of the present invention, an article including the biodegradable polyester resin is provided. Examples of the article including the biodegradable polyester resin may be packaging containers, packaging vinyl, coated paper films, coated flooring films and the like.

The articles including the biodegradable polyester resin may be in a form of a sheet or film which is extrusion-molded. Hereinafter, the method of preparing the biodegradable polyester resin will be explained in detail.

The biodegradable polyester resin may be prepared by an esterification reaction and a polycondensation reaction of a diol compound including the cycloaliphatic diol and the aliphatic diol; and a dicarboxylic acid compound including at least one of the aromatic dicarboxylic acid compound, the aliphatic dicarboxylic acid compound, and the cycloaliphatic dicarboxylic acid compound.

In detail, an oligomer having an ester bond is produced by an esterification reaction of a diol compound including 1,4-cyclohexanedimethanol and ethylene glycol; and a dicarboxylic acid compound including at least one of dimethylterephthalate, succinic acid, adipic acid, and 1,4-cyclohexanedicarboxylic acid. Then, by a polycondensation reaction of the oligomer, the biodegradable polyester resin may be prepared.

In the esterification reaction, the amount of the diol compound including the cycloaliphatic diol and the aliphatic diol used herein may be in a range of about 1.0 part by mole to about 2.0 parts by mole based on 1 part by mole of the total amount of the dicarboxylic acid compound used. For example, the amount of diol compound used may be about 2 parts by mole based on 1 part by mole of the total amount of the dicarboxylic acid compound used.

When the amount of the diol compound including the cycloaliphatic diol and the aliphatic diol used is respectively within the aforementioned range, the dicarboxylic acid compound reacts completely; depolymerization, in which the ester bond is broken by an acidolysis reaction due to residual dicarboxylic acid compound, is less likely to occur; and an increase of the cost due to excessive use of the diol compound can be prevented.

The amounts of the cycloaliphatic diol and the aliphatic diol used herein are about 0.05 part by mole to about 0.3 part by mole and about 0.7 part by mole to about 0.95 part by mole, respectively, based on 1 part by mole of the total amount of the diol compound used.

The cycloaliphatic diol is not vaporized at the esterification reaction temperature. Accordingly, almost the entire amount of the cycloaliphatic diol reacts with the dicarboxylic acid compound in the esterification reaction. Meanwhile, the aliphatic diol is vaporized at the esterification reaction temperature due to the small molecular weight thereof, and only the residual aliphatic diol, which is not vaporized, reacts with the dicarboxylic acid compound. Therefore, the amount of the aliphatic diol used herein is greater than that of the cycloaliphatic diol used.

The amounts of the aromatic dicarboxylic acid compound, the aliphatic dicarboxylic acid compound, and the cycloaliphatic dicarboxylic acid compound used herein are about 0 part by mole to about 0.7 part by mole, about 0 part by mole to about 0.5 part by mole, and about 0 part by mole to about 1.0 part by mole, respectively, based on 1 part by mole of the amount of dicarboxylic acid compound used.

Such an esterification reaction may occur at in a temperature range of about 170° C. to about 210° C. for about 120 minutes to about 200 minutes.

The end point of the esterification reaction may be determined by the amount of alcohol or water by-produced in the reaction. For example, when 1,4-cyclohexanedimethanol and ethylene glycol are used as the diol compound respectively in amounts of 0.6 mol and 1.4 mol, and dimethylterephthalate and succinic acid are used as the dicarboxylic acid compound respectively in amounts of 0.7 mol and 0.3 mol while assuming the total amount of dimethylterephthalate and succinic acid used herein reacts with ethylene glycol and 1,4-cyclohexanedimethanol, the esterification reaction may be ended when the amount of methanol and water by-produced in the reaction reaches 95% or more of the expected amounts of 1.4 mol of methanol and 0.6 mol of water, i.e. 1.33 mol or more of methanol, and 0.57 mol or more of water.

To increase the reaction rate by shifting the chemical equilibrium in the esterification reaction, the by-produced alcohol, the by-produced water and/or the unreacted diol compound may be discharged out of this reaction system by vaporization and distillation.

To facilitate the esterification reaction, a catalyst, a thermal stabilizer, and/or a branching agent may be further added thereto.

Examples of the catalyst may include magnesium acetate, tin (II) acetate, tetra-n-butyl titanate (TBT), lead acetate, sodium acetate, potassium acetate, antimony trioxide, N, N-dimethylaminopyridine, N-methylimidazole, and a combination thereof. The catalyst is usually added together with the monomer when a monomer is added to a reactor. For example, the catalyst may be added in an amount of about 0.00001 part by mole to about 0.2 part by mole based on 1 part by mole of the total amount of the dicarboxylic acid compound and the derivatives thereof. When the amount of the catalyst used is within the aforementioned range, a reaction time may be reduced and the desired degree of polymerization may be obtained.

The thermal stabilizer may be an organic or inorganic phosphorus compound. Examples of the organic or inorganic phosphorus compound may include phosphoric acid or an organic ester thereof, phosphorous acid or an organic ester thereof, a combination thereof. Examples of the thermal stabilizer may also include commercially available materials such as phosphoric acid and alkyl or allyl phosphate. Examples of the thermal stabilizer may also include triphenyl phosphate (TPP). For example, when the catalyst and the thermal stabilizer are used together, the amount of the thermal stabilizer used herein may be in a range of about 0.00001 part by mole to about 0.2 part by mole based on 1 part by mole of the total amount of the dicarboxylic acid compound and/or the derivatives thereof. When the amount of the thermal stabilizer used is within the aforementioned range, the biodegradable polyester resin may be prevented from deterioration and discoloration.

The branching agent is used for controlling the properties and biodegradability of the polyester resin. The branching agent may be a compound that has three or more groups, which are capable of forming an ester or amide, selected from a carboxyl group, a hydroxyl group, and an amine group. Examples of the branching agent may include trimellitic acid, citric acid, maleic acid, glycerol, monosaccharides, disaccharides, dextrin, or reduced sugar. The amount of the branching agent used herein may be in a range of about 0.00001 part by mole to about 0.2 part by mole based on 1 part by mole of the total amount of the dicarboxylic acid compound used.

The esterification reaction may be conducted at a normal pressure. The term “normal pressure” used herein refers to a pressure between about 750 torr and about 770 ton.

By the esterification reaction, an oligomer having an ester bond is produced.

The esterification reaction product (oligomer) may be additionally polycondensed in order to increase molecular weight thereof. The polycondensation reaction may occur in a temperature range of about 230° C. to about 270° C. for about 80 minutes to about 210 minutes.

The polycondensation reaction may be conducted at a vacuum pressure of 1 ton or less. By conducting the polycondensation reaction under vacuum pressure, a biodegradable polyester resin having higher molecular weight may be obtained while an unreacted source material (unreacted monomer), a low molecular weight oligomer, and by-produced water are removed.

One or more embodiments of the present invention will be explained in further detail, but the present invention is not limited thereto.

### Mode of the Invention

### EXAMPLES

### Examples 1 and 2

### Synthesis of PECST

(Esterification Reaction)

Dimethylterephthalate (DMT), ethylene glycol (EG: first input), 1,4-cyclohexanedimethanol (CHDM), tetra-n-butyl titanate (TBT), and malic acid (MA) in amounts shown in Table 1 below were loaded into a 500 ml 3-neck round bottom flask equipped with a condenser, a nitrogen inlet, and a stirrer to prepare a mixture. Then, the mixture was heated to 200° C. and reacted while stirring in a nitrogen atmosphere until 95% or more of the theoretical amount of methanol (i.e. about 53.75 ml) was discharged. Here, the produced methanol was completely discharged out of this system through the condenser. After the reaction completed, succinic acid (SA), EG (second input), antimony trioxide (AT) and triphenylphosphate (TPP) in amounts shown in Table 1 below were additionally loaded into the 3-neck round bottom flask and reacted while stirring until 95% or more of the theoretical amount of water (i.e. 10.26 ml) was discharged. Here, the produced water was completely discharged out of this system through the condenser. The amounts of monomers and additives used in each Example are shown in the Table 1 below.

(Polycondensation Reaction)

Next, the 3-neck round bottom flask was heated up to the temperature of 265° C. under a vacuum pressure of 1 torr or less, and then the reaction was conducted for 120 minutes. Then, the contents of the flask were discharged. As a result, PECST was obtained.

### Example 3

### Synthesis of PECAT

PECAT was synthesized in the same method as Examples 1 and 2 except that adipic acid (AA) was used instead of SA.

### Example 4

### Synthesis of P12PCST

P12PCST was synthesized in the same method as Examples 1 and 2 except that 1,2-propanediol (PDO) was used instead of EG.

### Example 5

### Synthesis of PECCT (CHDA:DMT=3:7)

PECCT was synthesized in the same method as Examples 1 and 2 except that 1,4-cyclohexanedicarboxylic acid (CHDA) was used instead of SA.

### Example 6

### Synthesis of PECCT (CHDA:DMT=5:5)

PECCT was synthesized in the same method as Examples 1 and 2 except that 86.09 g (0.5 mol) of 1,4-cyclohexanedicarboxylic acid (CHDA) was used instead of SA; the amount of dimethylterephthalate (DMT) used herein was changed to 97.09 g (0.5 mol); and the esterification reaction was conducted until 38.4 ml of methanol and 17.1 ml of water were discharged.

### Example 7

### Synthesis of PECSAT

PECSAT was synthesized in the same method as Examples 1 and 2 except that the amount of AA shown in Table 1 was additionally added when SA was added.

The amounts of monomers and additives used in Examples are shown in Table 1 below

### Comparative Example 1

### Synthesis of PEST

1Poly(ethylene succinate terephthalate) (PEST) was synthesized in the same method as Examples 1 and 2 except that CHDM was not used herein; the amounts of SA and DMT used herein were changed to 59.05 g (0.5 mol) and 97.09 g (0.5 mol), respectively; and the esterification reaction was conducted until 38.4 ml of methanol and 17.1 ml of water were discharged.

### Comparative Example 2

### Synthesis of PEST

PEST was synthesized in the same method as Examples 1 and 2 except that CHDM was not used herein.

The amounts of monomers and additives used in Comparative Examples are shown in Table 1 below.

TABLE 1

| | EG/ | | | | | | | | |
|---|---|---|---|---|---|---|---|---|---|
| | 1,2-PDO | | CHDM | SA/AA/CHDA | DMT | TBT | MA | AT | TPP |
| | first | second | (g(mol)) | (g(mol)) | (g(mol)) | (g(mmol)) | (g(mmol)) | (g(mmol)) | (g(mmol)) |
| Example 1 | EG | EG | 43.26 | SA | 135.93 | 0.2 | 0.4 | 0.05 | 1.0 |
| | 86.9 | 18.62 | (0.3) | 35.43 | (0.7) | (0.587) | (2.98) | (0.17) | (3.07) |
| | (1.4) | (0.3) | | (0.3) | | | | | |
| Example 2 | EG | EG | 86.53 | SA | 135.93 | 0.2 | 0.4 | 0.05 | 1.0 |
| | 68.28 | 18.62 | (0.6) | 35.43 | (0.7) | (0.587) | (2.98) | (0.17) | (3.07) |
| | (1.1) | (0.3) | | (0.3) | | | | | |
| Example 3 | EG | EG | 86.53 | AA | 135.93 | 0.2 | 0.4 | 0.05 | 1.0 |
| | 68.28 | 18.62 | (0.6) | 43.83 | (0.7) | (0.587) | (2.98) | (0.17) | (3.07) |
| | (1.1) | (0.3) | | (0.3) | | | | | |
| Example 4 | 1,2-PDO | 1,2-PDO | 43.26 | SA | 135.93 | 0.2 | 0.4 | 0.05 | 1.0 |
| | 106.53 | 22.83 | (0.3) | 35.43 | (0.7) | (0.587) | (2.98) | (0.17) | (3.07) |
| | (1.4) | (0.3) | | (0.3) | | | | | |
| Example 5 | EG | EG | 86.53 | CHDA | 135.93 | 0.2 | 0.4 | 0.05 | 1.0 |
| | 68.28 | 18.62 | (0.6) | 51.65 | (0.7) | (0.587) | (2.98) | (0.17) | (3.07) |
| | (1.1) | (0.3) | | (0.3) | | | | | |
| Example 6 | EG | EG | 86.53 | CHDA | 97.09 | 0.2 | 0.4 | 0.05 | 1.0 |
| | 68.28 | 18.62 | (0.6) | 86.09 | (0.5) | (0.587) | (2.98) | (0.17) | (3.07) |
| | (1.1) | (0.3) | | (0.5) | | | | | |
| Example 7 | EG | EG | 86.53 | SA: | 97.09 | 0.2 | 0.4 | 0.05 | 1.0 |
| | 68.28 | 18.62 | (0.6) | 23.62 (0.2) | (0.5) | (0.587) | (2.98) | (0.17) | (3.07) |
| | (1.1) | (0.3) | | AA: | | | | | |
| | | | | 14.61(0.1) | | | | | |
| Comparative | EG | EG | 0 | SA | 97.09 | 0.2 | 0.4 | 0.05 | 1.0 |
| Example 1 | 74.48 | 18.62 | (0) | 59.05 | (0.5) | (0.587) | (2.98) | (0.17) | (3.07) |
| | (1.2) | (0.3) | | (0.5) | | | | | |
| Comparative | EG | EG | 0 | SA | 135.93 | 0.2 | 0.4 | 0.05 | 1.0 |
| Example 2 | 74.48 | 18.62 | (0) | 35.43 | (0.7) | (0.587) | (2.98) | (0.17) | (3.07) |
| | (1.2) | (0.3) | | (0.3) | | | | | |

### Evaluation Example 1

The weight average molecular weight (Mw) and the glass transition temperature (T_{g}) of the biodegradable polyester resins synthesized in Examples 1-7 and Comparative Examples 1 and 2 were measured in the following methods and the results thereof are shown in the Table 2 below.

<Measurement of Mw>

With a gel-permeation chromatography (GPC), the weight average molecular weight (Mw) was measured by analyzing a dilute solution in which each of the biodegradable polyester resins synthesized in Examples 1-7 and Comparative Examples 1 and 2 was diluted in chloroform such that concentration of the resin therein was 1 wt %. The results thereof are shown in the Table 2 below. Here, a measurement temperature was 35° C. and a flow rate was 1 ml/min.

<Measurement of T_{g}>

With a a differential scanning calorimeter (DSC) (Q2000, manufactured by TA Instruments), the glass transition temperature (T_{g}) was measured by preheating each of the room-temperature resins synthesized in Examples 1-7 and Comparative Examples 1 and 2 to about 200° C. at a heating rate of about 10° C./min, and then cooling the each resin from about 200° C. to about −70° C. at a cooling rate of about 10° C./min, and finally reheating the each resin from about −70° C. to about 200° C. at a heating rate of about 10° C./min. The results thereof are shown in the Table 2 below.

TABLE 2

| | Mw(g/mol) | Tg(° C.) |
|---|---|---|
| Example 1 | 102,000 | 43 |
| Example 2 | 147,000 | 47 |
| Example 3 | 98,000 | 37 |
| Example 4 | 53,000 | 52 |
| Example 5 | 102,000 | 64 |
| Example 6 | 102,000 | 53 |
| Example 7 | 99,000 | 40 |
| Comparative | 115,000 | 23 |
| Example 1 | | |
| Comparative | 46,000 | 35 |
| Example 2 | | |

Referring to Table 2 above, it was found that the biodegradable polyester resins prepared in Examples 1-7 had a higher T_{g} than the biodegradable polyester resins prepared in Comparative Examples 1 and 2.

Moreover, the biodegradable polyester resins prepared in Examples 5 and 6 had a higher T_{g} than the biodegradable polyester resins prepared in Examples 1-4 and 7 since the biodegradable polyester resins prepared in Examples 5 and 6 further include a residue derived from 1,4-cyclohexanedicarboxylic acid, and thus have high irregularities in molecular structure.

### Evaluation Example 2

Flexural strength, flexural modulus and notched izod impact strength of the resins prepared in Examples 1-7, PLA for extrusion (Natureworks, 2003D), PLA for films (Natureworks, 4032D), and high impact polystyrene (HIPS) (LG Chem, 651HE) were measured by the following methods, and the results thereof are shown in Table 3 below.

<Measurement of Flexural Strength and Flexural Modulus>

According to ASTM D790, a specimen having a length, width and thickness of 127 mm, 12.7 mm and 3.2 mm, respectively, was used in the measurement. In this case, the lower flexural strength and flexural modulus denotes the higher flexibility.

<Measurement of Notched Izod Impact Strength>

According to ASTM D256, NII bars having a length, width and thickness of about 63.5 mm, about 12.7 mm and about 3.2 mm, respectively, were prepared and used to measure a notched izod impact strength at 23° C.

TABLE 3

| | Flexural | Flexural | notched izod |
|---|---|---|---|
| | strength | modulus | impact strength |
| | (MPa) | (GPa) | (J/m) |
| Example 1 | 47.22 | 1.53 | 62 |
| Example 2 | 60.05 | 1.99 | 50 |
| Example 3 | 30.69 | 1.12 | 60 |
| Example 4 | 65.17 | 2.35 | 47 |
| Example 5 | 58.63 | 1.64 | 55 |
| Example 6 | 41.99 | 1.18 | 48 |
| Example 7 | 22.44 | 1.35 | 55 |
| Comparative | — | — | — |
| Example 1 | | | |
| Comparative | 72.33 | 2.84 | 43 |
| Example 2 | | | |
| PLA-2003D | 91.08 | 3.22 | 22 |
| PLA-4032D | 90.95 | 3.15 | 24 |
| HIPS | 45.08 | 2.22 | 120 |

Referring to Table 3, the resins prepared in Examples 1-7 had lower values of flexural strength and flexural modulus, and a higher value of notched izod impact strength compared to the resins prepared in Comparative Examples 1 and 2, PLA-2003D, and PLA-4032D. Also, the resins prepared in Examples 1-7 had lower values of flexural strength and flexural modulus compared to HIPS.

### Evaluation Example 3

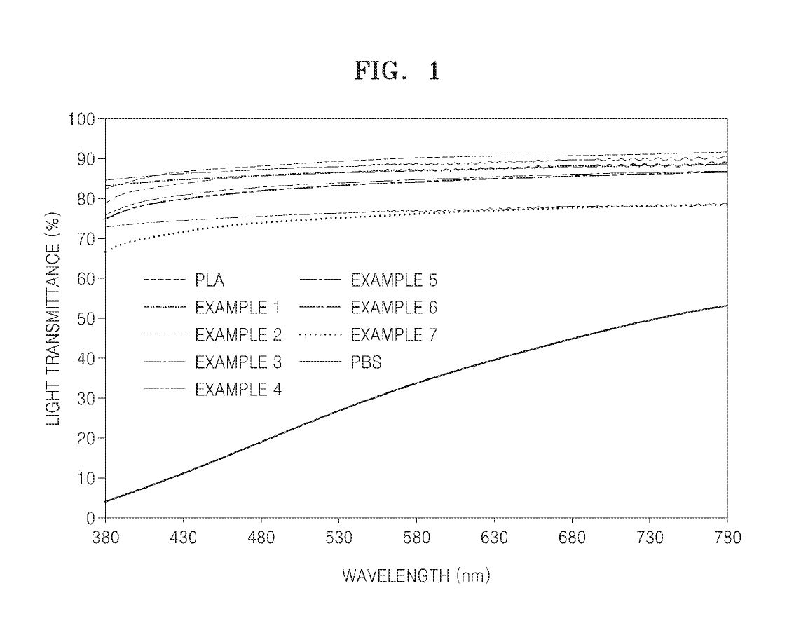

Transparency of the resins prepared in Examples 1-7, PLA resin (Natureworks, 2003D), and polybutylene succinate (PBS) resin (SFC, 4560M) were measured in the following methods, and the results thereof are shown in FIG. 1.

<Evaluation of Transparency>

(Manufacturing Film by Heat Press Method)

40 g of the each resin (20° C.) was put into a corresponding square mould which had an open bottom and top; a polyimide film disposed to cover the open bottom; and a length, width and height of 15 cm, 15 cm, and 400 μm, respectively, and then the mould was heated to 200° C. to melt the resin. Then, after placing the mould on the top of a heat press machine (Daeheung Science, DSP-20J) which was heated to 200° C., an additional polyimide film was disposed to cover the open top of the mould and a pressure of 20 bar was applied thereto for 5 minutes. Next, the mould was rapidly cooled by putting the mould into a water bath at 8° C. and then the contents of the mould were taken out of the mould and left at room temperature. Thus a film having a thickness of 400 μm was obtained.

((\Measurement of Light Transmittance)

With an UV spectrophotometer (LAMBDA 650 UV-VIS manufactured by PerkinElmer), light transmittance of the films manufactured in the above method were measured by irradiating each film with light having a wavelength of about 380 nm to about 780 nm (whole visible region). The results thereof are shown in FIG. 1. Here, the higher light transmittance denotes the higher transparency.

Referring to FIG. 1 below, it was confirmed that the resins prepared in Examples 1-7 have much higher transparency than the PBS resin and have the equivalent level of transparency as the PLA resin.

### Evaluation Example 4

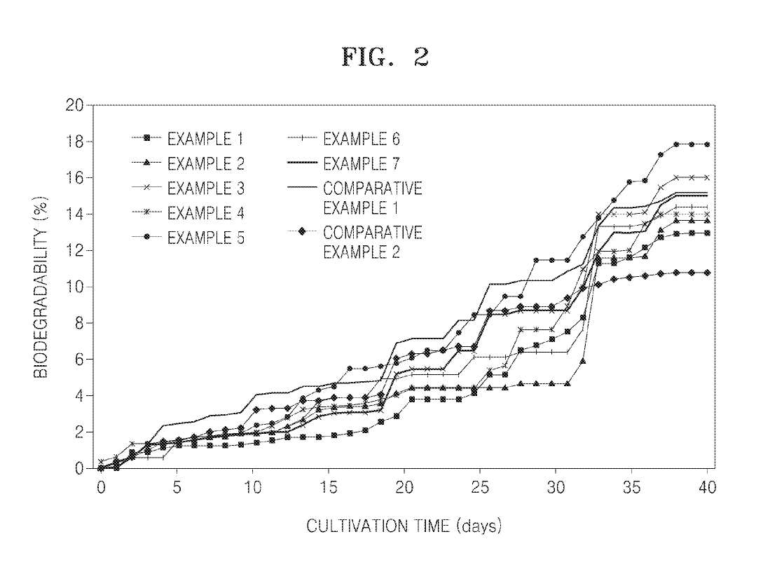

Biodegradability of the resins prepared in Examples 1-7 and Comparative Examples 1 and 2 were measured in the following methods, and the results thereof are shown in FIG. 2.

<Evaluation of Biodegradability>

According to ISO 14855-1 (2005), which is a method to measure an aerobic biodegradability of plastics under composting conditions, samples of the resins prepared in Examples 1-7 and Comparative Examples 1-2 were cultivated for 40 days at 58° C., using a biodegradability test system (Seongjin E&I). A cumulative biodegradability value for 40 days was calculated for each of Examples 1-7 and Comparative Examples 1-2 by Equation 1 below, and the results thereof are shown in FIG. 2. Here, the generated amount of carbon dioxide (CO₂), which was the final product of biodegradation, was measured with a gas chromatograph (YL 6100 GC manufactured by Younglin Science).

[Equation 1]

Biodegradability (%)={[CO₂]sf*100/[CO₂]st}*100/{[CO₂]cf*100/[CO₂]ct}

[CO₂]sf: a cumulative amount of CO₂ generated when the sample biodegraded over a period of 40 days.

[CO₂]st: the maximum possible amount of CO₂ to be generated when the sample fully biodegraded, that is, by 100%.

[CO₂]cf: a cumulative amount of CO₂ generated when a cellulose, which is a reference sample, biodegraded over 40 days.

[CO₂]ct: the maximum possible amount of CO₂ to be generated when a cellulose, which is a reference sample, fully biodegraded, that is, by 100%.

Referring to FIG. 2, it was confirmed that the resins prepared in Examples in 1-7 had biodegradability. In other words, the biodegradable polyester resins had biodegradability as well as an excellent transparency and flexibility.

While one or more embodiments of the present invention have been described with reference to the views, the invention may, however, be embodied in many different forms and should not be construed as being limited to the embodiments set forth herein; rather, these embodiments are provided so that the disclosure will be through and complete, and will fully convey the concept of the invention to those of ordinary skill in the art.

1. A biodegradable polyester resin comprising:
a diol residue (DO) comprising a cycloaliphatic diol residue (A) and an aliphatic diol residue (B); and
a dicarboxylic acid residue (DC) comprising at least one of an aromatic dicarboxylic acid residue (C), an aliphatic dicarboxylic acid residue (D), and a cycloaliphatic dicarboxylic acid residue (E).

2. The biodegradable polyester resin of claim 1, wherein the cycloaliphatic diol residue (A) comprises a residue derived from at least one cycloaliphatic diol compound that is selected from the group consisting of 2,2,4,4-tetramethyl-1,3-cyclobutanediol, 1,2-cyclopentanediol, 1,3-cyclopentanediol, 1,2-cyclopentane dimethanol, 1,3-cyclopentane dimethanol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, and a combination thereof,
the aliphatic diol residue (B) comprises a residue derived from at least one diol compound that is selected from the group consisting of ethylene glycol and a branched aliphatic diol (B-DO) having an ethylene glycol moiety, wherein the branched aliphatic diol (B-DO) comprises at least one aliphatic diol compound selected from the group consisting of 1,2-propanediol, 2,3-butanediol, 2-methyl-2,3-butanediol, 2,3-dimethyl-2,3-butanediol, 4-methyl-2,3-pentanediol, and a combination thereof,
the aromatic dicarboxylic acid residue (C) comprises a residue derived from at least one aromatic dicarboxylic acid compound that is selected from the group consisting of terephthalic acid, isophthalic acid, naphthoic acid, naphthalene dicarboxylic acid, and a derivative thereof,
the aliphatic dicarboxylic acid residue (D) comprises a residue derived from at least one aliphatic dicarboxylic acid compound that is selected from the group consisting of succinic acid, glutaric acid, adipic acid, pimelic acid, suberic acid, azelaic acid, maleic acid, malonic acid, oxalic acid, sebacic acid, and a derivative thereof, and
the cycloaliphatic dicarboxylic acid residue (E) comprises a residue derived from at least one cycloaliphatic dicarboxylic acid compound that is selected from the group consisting of cyclobutane dicarboxylic acid, cyclopentane dicarboxylic acid, cyclohexane dicarboxylic acid, and a derivative thereof.

3. The biodegradable polyester resin of claim 1, wherein an amount of the diol residue (DO) is in a range of about 1.0 part by mole to about 2.0 parts by mole based on 1 part by mole of the dicarboxylic acid residue (DC).

4. The biodegradable polyester resin of claim 1, wherein amounts of the cycloaliphatic diol residue (A) and the aliphatic diol residue (B) are in ranges of about 0.1 part by mole to about 0.6 part by mole, and about 0.4 part by mole to about 0.9 part by mole, respectively, based on 1 part by mole of the diol residue (DO), and
amounts of the aromatic dicarboxylic acid residue (C), the aliphatic dicarboxylic acid residue (D), and the cycloaliphatic dicarboxylic acid residue (E) are in ranges of 0 to about 0.7 part by mole, 0 to about 0.5 part by mole, and 0 to about 1.0 part by mole, respectively, based on 1 part by mole of the dicarboxylic acid residue (DC).

5. The biodegradable polyester resin of claim 1, wherein the biodegradable polyester resin has a weight average molecular weight (Mw) in a range of about 50,000 to about 150,000.

6. The biodegradable polyester resin of claim 1, wherein the biodegradable polyester resin has a glass transition temperature (T_{g}) of 25° C. or greater.

7. The biodegradable polyester resin of claim 1, wherein the biodegradable polyester resin comprises at least one compound selected from poly(ethylene-1,4-cyclohexanedimethylene succinate terephthalate) (PECST), poly(ethylene-1,4-cyclohexanedimethylene adipate terephthalate) (PECAT), poly(l,2-propylene-1,4-cyclohexanedimethylene succinate terephthalate) (P12PCST), poly(ethylene-1,4-cyclohexanedimethylene 1,4-cyclohexane dicarboxylate terephthalate) (PECCT) and poly(ethylene-1,4-cyclohexanedimethylene succinate adipate terephthalate) (PECSAT).

8. An article comprising the biodegradable polyester resin according to claim 1.
